(19) United States
(12) Patent Application Publication
(10) Pub. No.: US 2007/0064955 A1
(43) Pub. Date: Mar. 22, 2007

(54) Electronic apparatus and method of controlling driving of speaker

(75) Inventor: Kazuyuki Saito, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaishi Toshiba, Tokyo (JP)

(21) Appl. No.: 11/472,994

(22) Filed: Jun. 23, 2006

(30) Foreign Application Priority Data
Jun. 24, 2005 (JP) 2005-185327

(51) Int. Cl. H04R 29/00

(52) U.S. Cl. 381/58; 381/59

(57) ABSTRACT

According to one embodiment, a computer comprises piezoelectric speakers and dynamic speakers. An EC/KBC discriminates whether the computer is driven by an external power or a battery. When the computer is driven by the external power, the EC/KBC permits the driving of the dynamic speakers. When the computer is driven by the battery, the EC/KBC permits the driving of the piezoelectric speakers and prohibits the driving of the dynamic speakers.

### CROSS-REFERENCE TO RELATED APPLICATIONS

This application is based upon and claims the benefit of priority from Japanese Patent Application No. 2005-185327, filed Jun. 24, 2005, the entire contents of which are incorporated herein by reference.

### BACKGROUND

1. Field

One embodiment of the invention relates to an electronic apparatus such as a portable computer and a method of controlling driving of a speaker employed in the electronic apparatus.

2. Description of the Related Art

In general, a portable-type personal computer comprising the same AV function as an audio-video (AV) device such as a DVD (digital versatile disc) player and a TV unit, is equipped with a dynamic speaker as a speaker for reproducing an audio signal. A dynamic speaker is in a type in which a vibration plate is moved by flowing a current to a coil arranged in a magnetic field and sounds are thereby output. The dynamic speaker can reproduce high-quality audio signals while consuming a comparatively great amount of electric power.

On the other hand, a piezoelectric speaker is known as a low power-consumption speaker. The piezoelectric speaker is in a type in which an electric signal is converted into a sound pressure by utilizing a piezoelectric element. Its power consumption is extremely lower than that of a dynamic speaker utilizing a coil. For this reason, if the portable-type personal computer is equipped with the piezoelectric speaker instead of the dynamic speaker, the battery driving time of the personal computer can be extended.

However, the piezoelectric speaker has a demerit that distortion in a reproduced sound is great and reproduction of low audio frequencies is difficult.

The portable-type personal computer is required to reproduce music of a sufficiently high sound quality at home. Thus, it is actually difficult to equip the portable-type personal computer with the piezoelectric speaker instead of the dynamic speaker.

For example, Jpn. Pat. Appln. KOKAI Publication No. 2004-96573 discloses a cellular telephone having two speakers of the same kind, a front speaker and a back speaker. To save the power consumption, the only rear speaker is driven when the cellular telephone is folded.

However, the front speaker and the rear speaker are of the same kind in the cellular telephone of Jpn. Pat. Appln. KOKAI Publication No. 2004-96573. Even if the driving of the front speaker is stopped, the power consumption can only be reduced by up to half.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an outer appearance of an information processing apparatus according to an embodiment of the present invention;

FIG. 2 is an illustration showing sound fields corresponding to respective piezoelectric speakers and dynamic speakers provided on the information processing apparatus shown in FIG. 1;

FIG. 3 is a block diagram showing a first example of a system configuration of the information processing apparatus shown in FIG. 1;

FIG. 4 is an illustration showing an example of an operation mode employed in the information processing apparatus shown in FIG. 1;

FIG. 5 is an illustration showing an icon displayed on a screen of the information processing apparatus shown in FIG. 1;

FIG. 6 is a flowchart showing a first example of steps of a speaker driving control processing executed in the information processing apparatus shown in FIG. 1;

FIG. 7 is a flowchart showing a second example of steps of the speaker driving control processing executed in the information processing apparatus shown in FIG. 1;

FIG. 8 is a block diagram showing a second example of a system configuration of the information processing apparatus shown in FIG. 1;

FIG. 9 is an illustration showing audio signal frequencies output from respective speakers provided in the information processing apparatus shown in FIG. 8;

FIG. 10 is a flowchart showing an example of steps of a speaker driving control processing executed in the information processing apparatus shown in FIG. 8;

FIG. 11 is an illustration showing another example of arrangement of piezoelectric speakers provided in the information processing apparatus shown in FIG. 1; and

FIG. 12 is a block diagram showing a third example of a system configuration of the information processing apparatus shown in FIG. 1.

### DETAILED DESCRIPTION

Various embodiments according to the invention will be described hereinafter with reference to the accompanying drawings. In general, according to one embodiment of the invention, the electronic apparatus comprises a main body, a dynamic speaker provided on the main body, a piezoelectric speaker provided on the main body, means for detecting whether the main body is driven by the battery or the external power, and control means for permitting the driving of the dynamic speaker, when detecting means detects that the main body is driven by the external power, and for permitting the driving of the piezoelectric speaker and prohibiting the driving of the dynamic speaker when detecting means detects that the main body is driven by the battery the dynamic speaker, when detecting means detects.

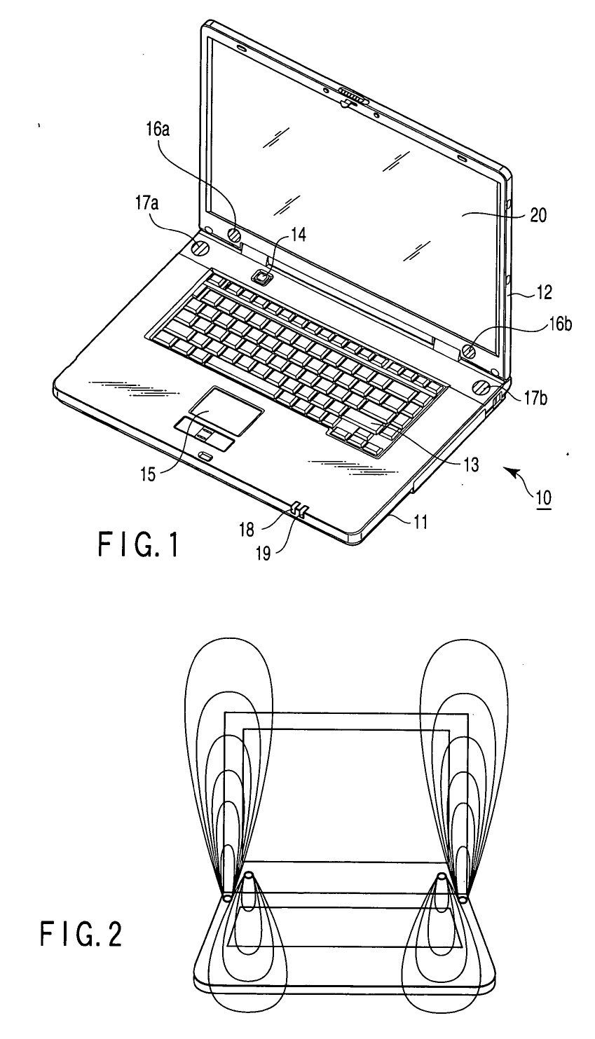

First, a structure of a portable electronic apparatus according to the embodiment of the present invention will be explained with reference to FIG. 1 to FIG. 3. This electronic apparatus is implemented as, for example, a portable notebook-type personal computer 10 which can be battery-powered.

FIG. 1 is a perspective view of the notebook-type personal computer 10 with a display unit opened. The main body of the computer 10 is composed of a base unit 11 and the display unit 12. A display device composed of a LCD (Liquid Crystal Display) 20 is built in an inner surface of the display unit 12. The display screen of the LCD 20 is arranged approximately at a center of the display unit 12. Furthermore, two piezoelectric speakers 16a and 16b are arranged on the inner surface of the display unit 12. The piezoelectric speaker 16a functions as an L-channel speaker and the piezoelectric speaker 16b functions as an R-channel speaker.

The display unit 12 is supported by a rear end portion of the base unit 11 and attached to the base unit 11 so as to freely pivot between an opened position at which a top surface of the base unit 11 is exposed and a closed position at which the top surface of the base unit 11 is covered. The base unit 11 is shaped in a thin housing. On the top surface of the base unit 11, a keyboard 13, a power button switch 14 for turning on/off the power to the computer 10, a touch pad 15, etc. are arranged. Moreover, two dynamic speakers 17a and 17b are arranged to face upward at the rear end side on the top surface of the base unit 11. In this case, each of the dynamic speakers 17a, 17b and each of the piezoelectric speakers 16a, 16b are displaced from each other along a direction of a rotary axis of the display unit 12. The dynamic speaker 17a functions as an L-channel speaker and the dynamic speaker 17b functions as an R-channel speaker.

Indicators 18, 19 are provided on the base unit 11 as display units which display status information representing speakers permitted to be driven. The indicator 18 represents whether or not the driving of the dynamic speakers 17a, 17b is permitted. The indicator 19 represents whether or not the driving of the piezoelectric speakers 16a, 16b is permitted.

Since the dynamic speakers 17a, 17b are arranged on the top surface of the base unit 11 to face upward as described above, the sound from the dynamic speakers 17a, 17b is emitted mainly upward as illustrated in FIG. 2. In particular, since the sound of high audio frequencies is easily extended upward, it is hardly extended to the front side of the computer 10. On the other hand, since the piezoelectric speakers 16a, 16b are arranged on the display unit 12, the sound from the piezoelectric speakers 16a, 16b is mainly emitted to the front side of the computer 10 as illustrated in FIG. 2. Since the piezoelectric speakers 16a, 16b are excellent in acoustic characteristics in middle and high audio frequencies, preferable sound of high audio frequencies can be emitted to the front side of the computer 10 by arranging the piezoelectric speakers 16a, 16b on the display unit 12. Therefore, preferable sound fields can be formed at the front side of the computer 10 where the user is located.

Furthermore, in this case, each of the dynamic speakers 17a, 17b and each of the piezoelectric speakers 16a, 16b are displaced from each other along the direction of the rotary axis of the display unit 12. Therefore, overlapping of the sound field from each of the dynamic speakers 17a, 17b and the sound field from each of the piezoelectric speakers 16a, 16b can be prevented.

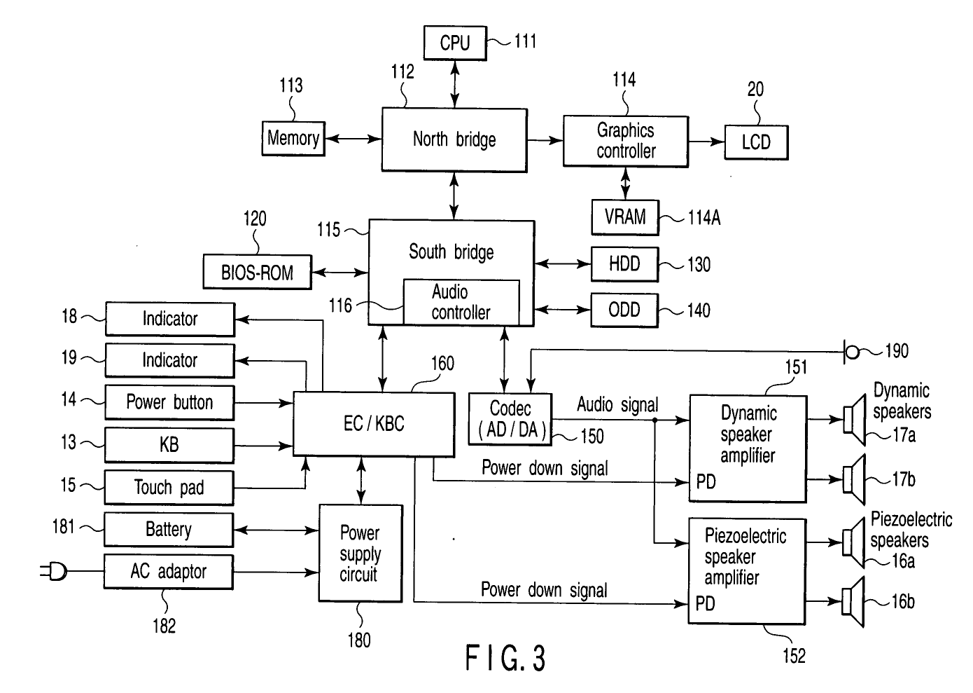

Next, a first example of the system configuration of the computer 10 will be explained with reference to FIG. 3.

The computer 10 comprises a CPU 111 (control means, detecting means), a north bridge 112, a main memory 113, a graphics controller 114, a south bridge 115, a BIOS-ROM 120, a hard disk drive (HDD) 130, an optical disk drive (ODD) 140, an audio codec (Codec) 150, a dynamic speaker amplifier 151, a piezoelectric speaker amplifier 152, an embedded controller/keyboard controller IC (EC/KBC) 160 and a power supply circuit 180, as shown in FIG. 3.

The CPU 111 is a processor for controlling operations of the computer 10. The CPU 111 executes an operating system and various kinds of application programs loaded on the main memory 113 from the hard disk drive (HDD) 130. The CPU 111 also executes a BIOS (Basic Input Output System) stored in the BIOS-ROM 120. The BIOS is a program for hardware control.

The north bridge 112 is a bridge device for making a connection between a local bus of the CPU 111 and the south bridge 115. The north bridge 112 has a function of executing communications with the graphics controller 114 via an AGP (Accelerated Graphics Port) bus, etc. The graphics controller 114 is a display controller for controlling the LCD 20 employed as the display monitor of the computer 10. The graphics controller 114 has a video memory (VRAM) 114A, and generates a display signal to be transmitted to the LCD 20 from the display data which are written in the video memory 114A by the operating system/application programs.

The south bridge 115 is connected to the BIOS-ROM 120, the HDD 130, the ODD 140, the audio codec (Codec) 150, and the embedded controller/keyboard controller IC (EC/KBC) 160. The south bridge 115 has, for example, an IDE (Integrated Drive Electronics) controller for controlling the HDD 130 and the ODD 140. The south bridge 115 also has an audio controller 116 for generating an audio signal. A digital signal mode of the audio signal output from the audio controller 116 is converted into an analog signal mode thereof by the audio codec 150, and the audio signal of the analog signal mode is transmitted to each of the dynamic speaker amplifier 151 and the piezoelectric speaker amplifier 152. The audio controller 116 executes a processing of receiving a speech signal input from a microphone 190 via the audio codec 150. In this case, an analog signal mode of the speech signal input from the microphone 190 is converted into a digital signal mode thereof by the audio codec 150, and the speech signal of the digital signal mode is transmitted to the audio controller 116.

The dynamic speaker amplifier 151 is an amplifier for driving the dynamic speakers 17a, 17b, which amplifies the audio signal input via the audio codec 150 and generates a signal for driving the dynamic speakers 17a, 17b. The dynamic speaker amplifier 151 has a power-down terminal (PD). If a PowerDown signal transmitted from the embedded controller/keyboard controller IC (EC/KBC) 160 is input to the power-down terminal (PD) of the dynamic speaker amplifier 151, the power to the dynamic speaker amplifier 151 is turned off and the driving of the dynamic speakers 17a, 17b is thereby prohibited.

The piezoelectric speaker amplifier 152 is an amplifier for driving the piezoelectric speakers 16a, 16b, which amplifies the audio signal input via the audio codec 150 and generates a signal for driving the piezoelectric speakers 16a, 16b. The piezoelectric speaker amplifier 152 also has a power-down terminal (PD). If the PowerDown signal transmitted from the embedded controller/keyboard controller IC (EC/KBC) 160 is input to the power-down terminal (PD) of the piezoelectric speaker amplifier 152, the power to the piezoelectric speaker amplifier 152 is turned off and the driving of the dynamic speakers 17a, 17b is thereby prohibited.

The embedded controller/keyboard controller IC (EC/KBC) 160 is a 1-chip microcomputer in which an embedded control for power management and a keyboard controller for controlling the keyboard (KB) 13 and the touch panel 15 are integrated. When the power button switch 14 is pushed down by the user, the EC/KBC 160 turns on the power to the computer 10 in cooperation with the power supply circuit 180. The EC/KBC 160 has a function of discriminating whether the computer 10 is driven by a battery 181 or an external power (external AC power) fed via an AC adaptor 182. The EC/KBC 160 also has a function of switching the speakers to be utilized, in accordance with whether the computer 10 is driven by the battery 181 or the external power. In the present embodiment, if the computer 10 is driven by the external power, at least the dynamic speakers 17a and 17b, of the dynamic speakers 17a, 17b and the piezoelectric speakers 16a, 16b, are used to put a high priority to sound quality. Concretely, the driving of the dynamic speakers 17a and 17b is permitted, and sound corresponding to the audio signal is output from the dynamic speakers 17a and 17b at the audio reproduction. On the other hand, if the computer 10 is driven by the battery 181, the piezoelectric speakers 16a, 16b are used while the use of the dynamic speakers 17a and 17b is prohibited, to give a higher priority to saving the power than to the sound quality. Concretely, the driving of the dynamic speakers 17a and 17b is prohibited and the only driving of the piezoelectric speakers 16a, 16b is permitted. At the audio reproduction, the sound corresponding to the audio signal is output from the piezoelectric speakers 16a, 16b.

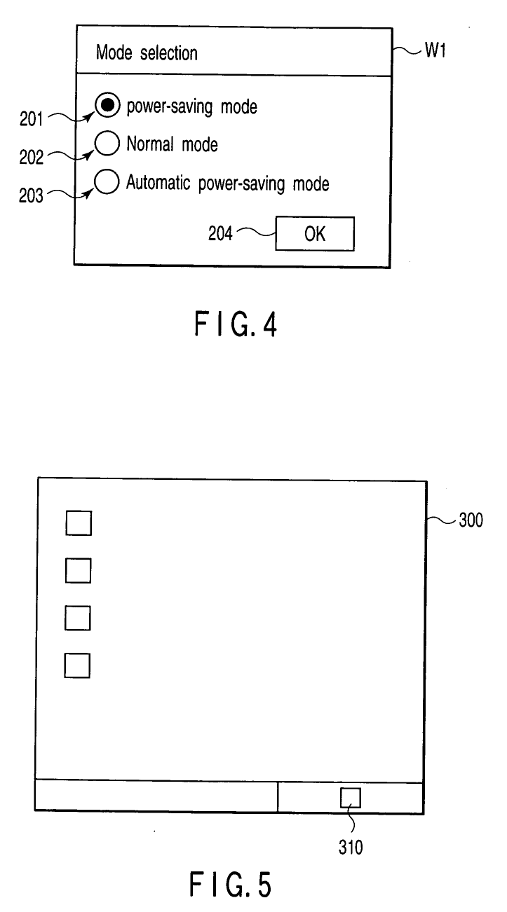

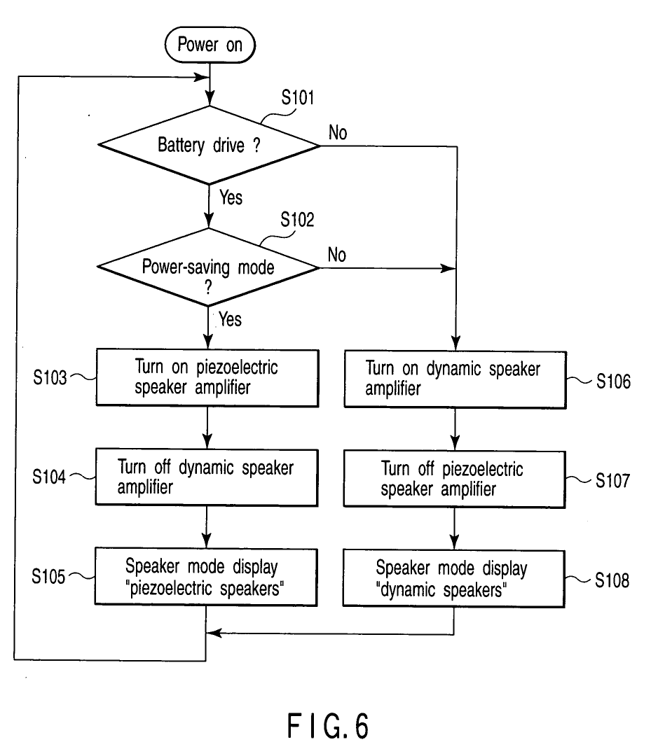

FIG. 4 shows an example of a mode selection screen for selection of the operation mode of the computer 10.

The computer 10 has three operation modes, i.e. power-saving mode, normal mode and automatic power-saving mode. The power-saving mode is the operation mode to extend battery operation time of the computer 10. When the power-saving mode is selected by the user, the speakers to be used are automatically switched in accordance with whether the computer 10 is driven by the external power or the battery 181.

The normal mode is the operation mode giving a higher priority to the system performance than to the power consumption. When the normal mode is selected by the user, the dynamic speakers 17a, 17b are always used irrespective of whether the computer 10 is driven by the external power or the battery 181.

The automatic power-saving mode is the mode at which when the computer 10 is driven by the battery 181, the operation mode of the computer 10 is switched to the power saving mode or the normal mode in accordance with the remaining capacity of the battery 181.

On the mode selection screen, three radio buttons 201, 202, 203 corresponding to the power-saving mode, the normal mode and the automatic power-saving mode, respectively, and an “OK” button 204 are shown. By selecting any one of the three buttons 201, 202, 203 and clicking the “OK” button 204, the user can set the operation mode of the computer 10 to the operation mode corresponding to the selected radio button.

FIG. 5 shows an example of a screen 300 displayed on the LCD 20. On the screen 300, an icon 310 for representing the status information indicating the speakers whose driving is permitted is displayed. Thanks to the icon 310, the user can confirm whether the speakers to be used are the piezoelectric speakers 16a, 16b or the dynamic speakers 17a, 17b.

Next, a first example of steps of the speaker driving control processing executed by the computer 10 is explained.

When the power to the computer 10 is turned on, the EC/KBC 160 cooperates with the power supply circuit 180 to discriminate whether the computer 10 is driven by the battery 181 or the external power (step S101). If the AC adaptor 182 is connected to the computer 10, i.e. if the external power is supplied to the computer 10, the EC/KBC 160 discriminates that the computer 10 is driven by the external power. On the other hand, if the AC adaptor 182 is not connected to the computer 10, i.e. if the external power is not supplied to the computer 10, the EC/KBC 160 discriminates that the computer 10 is driven by the battery 181.

If the EC/KBC 160 discriminates that the computer 10 is driven by the battery 181 (YES in step S101), the EC/KBC 160 discriminates whether or not the operation mode of the computer 10 is the power-saving mode (step S102). In step S102, the EC/KBC 160 discriminates the operation mode of the computer 10, by referring to the setup information to designate the operation mode as set in the register provided in the EC/KBC 160, etc.

If the operation mode of the computer 10 is the power-saving mode (YES in step S102), the EC/KBC 160 turns on the power to the piezoelectric speaker amplifier 152 to permit the driving of the piezoelectric speakers 16a, 16b (step S103). In step S103, the EC/KBC 160 stops the output of the PowerDown signal to the piezoelectric speaker amplifier 152. The power to the piezoelectric speaker amplifier 152 is thereby turned on. Next, the EC/KBC 160 turns off the power to the dynamic speaker amplifier 151 to prohibit the driving of the dynamic speakers 17a, 17b (step S104). In step S104, the EC/KBC 160 outputs the PowerDown signal to the dynamic speaker amplifier 151. The power to the dynamic speaker amplifier 151 is thereby turned off. The EC/KBC 160 executes the processing of showing the information indicating that the speakers to be used are the piezoelectric speakers 16a, 16b, i.e. that the driving of the piezoelectric speakers 16a, 16b is permitted (step S105). In step 105, the EC/KBC 160 cooperates with the power supply circuit 180 to turn on the light on the indicator 19. Furthermore, the EC/KBC 160 cooperates with the display driver controlling the graphics controller 114, etc. to urge the icon 310 indicating that the speakers to be used are the piezoelectric speakers 16a, 16b to be displayed on the screen of the LCD 20.

On the other hand, if the EC/KBC 160 discriminates that the computer 10 is driven by the external power (NO in step S101) or if the computer 10 is set in the normal mode (NO in step S102), the EC/KBC 160 turns on the power to the dynamic speaker amplifier 151 to permit the driving of the dynamic speakers 17a, 17b (step S106). In step S106, the EC/KBC 160 stops the output of the PowerDown signal to the dynamic speaker amplifier 151. The power to the dynamic speaker amplifier 151 is thereby turned on. Next, the EC/KBC 160 turns off the power to the piezoelectric speaker amplifier 152 to prohibit the driving of the piezoelectric speakers 16a, 16b (step S107). In step S107, the EC/KBC 160 transmits the PowerDown signal to the piezoelectric speaker amplifier 152. The power to the piezoelectric speaker amplifier 152 is thereby turned off. The EC/KBC 160 executes the processing of showing the information indicating that the speakers to be used are the dynamic speakers 17a, 17b, i.e. that the driving of the dynamic speakers 17a, 17b is permitted (step S108). In step 108, concretely, the EC/KBC 160 cooperates with the power supply circuit 180 to turn on the light on the indicator 18. Furthermore, the EC/KBC 160 cooperates with the display driver, etc. to urge the icon 310 indicating that the speakers to be used are the dynamic speakers 17a, 17b to be displayed on the screen of the LCD 20.

The above-described processing is periodically repeated while the power to the computer 10 is turned on.

In the present embodiment, the dynamic speakers 17a, 17b can be used when the external power is supplied to the computer 10. Thus, for example, if the audio data are reproduced at home by the computer 10, the sounds of sufficiently high quality can be output. On the other hand, if the external power is not supplied to the computer 10 but the computer 10 is driven by the battery 181, the available speakers are automatically switched from the dynamic speakers 17a, 17b to the piezoelectric speakers 16a, 16b that consume a smaller amount of power than the dynamic speakers 17a, 17b. In general, the power consumption of the piezoelectric speakers 16a, 16b is not more than approximately one third as great as that of the dynamic speakers 17a, 17b. Therefore, the battery operation time of the computer 10 can be extended.

Furthermore, in the present embodiment, since the driving of the speakers is prohibited by turning off the power to the amplifier, it is possible to prevent standby power consumption from being wasted by the amplifier corresponding to the speakers not to be used.

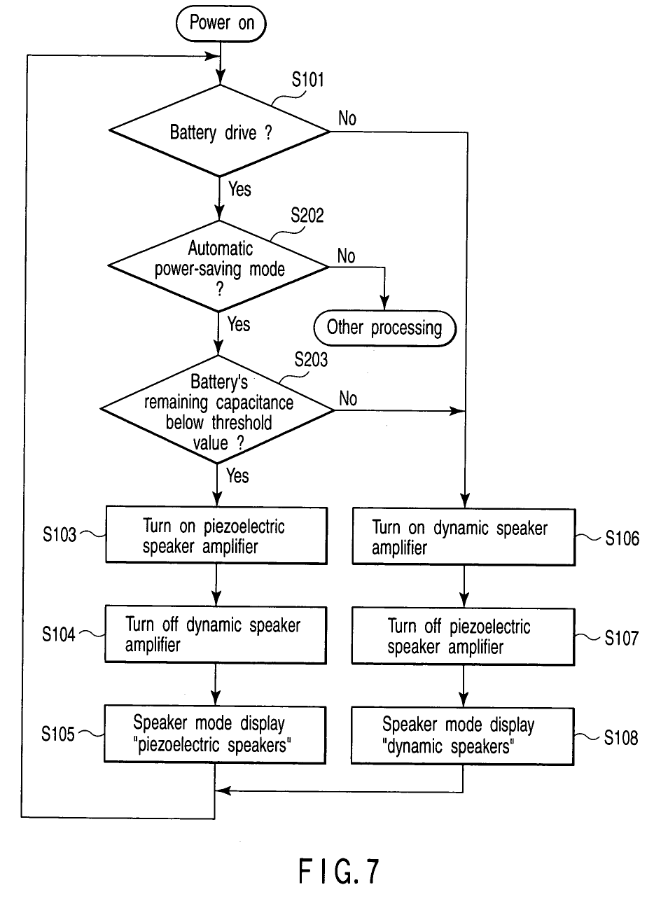

Next, processing executed when the computer 10 is driven by the battery 181 and when the operation mode of the computer 10 is set at the automatic power-saving mode is explained with reference to FIG. 7.

If the computer 10 is driven by the battery 181 (YES in step S101) and the operation mode of the computer 10 is set at the automatic power-saving mode (YES in step S202), the EC/KBC 160 discriminates whether or not the remaining capacity of the battery 181 is equal to or below a predetermined threshold value (step S203). If the remaining capacity of the battery 181 is equal to or below the predetermined threshold value (YES in step S203), the EC/KBC 160 executes the above-described processing in steps S103 to S105. On the other hand, if the remaining capacity of the battery 181 is above the predetermined threshold value (NO in step S203), the EC/KBC 160 executes the above-described processing in steps S106 to S108.

The processing of FIG. 7 is periodically repeated while the power to the computer 10 is turned on.

Irrespective of the operation mode of the computer 10, the processing in steps S103 to S105 may be executed unconditionally when the computer 10 is driven by the battery and the processing in steps S106 to S108 may be executed unconditionally when the computer 10 is driven by the external power.

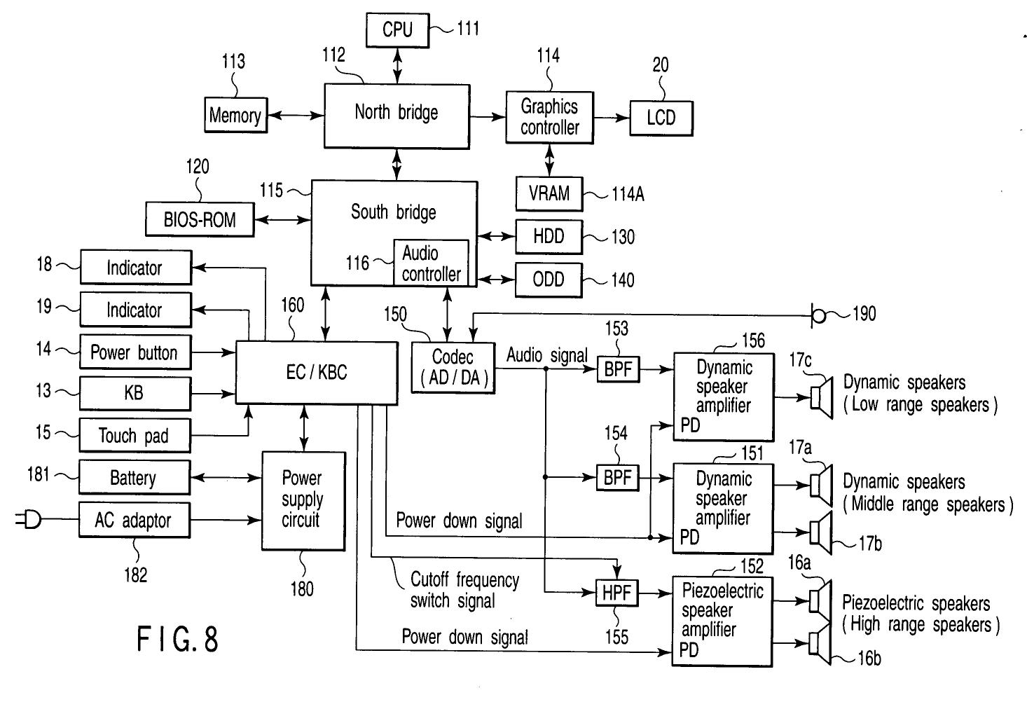

Next, a second example of the system configuration of the computer 10 is explained with reference to FIG. 8.

Elements like or similar to those shown in FIG. 3 are denoted by similar reference numbers in FIG. 8 and are not described in detail here. In the second example, a dynamic speaker 17c, a dynamic speaker amplifier 156, band-pass filters (BPF) 153, 154 and a high-pass filter (HPF) 155 are provided besides the piezoelectric speakers 16a, 16b and the dynamic speakers 17a, 17b.

The dynamic speaker amplifier 156 is an amplifier for driving the dynamic speaker 17c, which amplifies the audio signal input via the band-pass filter (BPF) 153 and generates a signal to drive the dynamic speaker 17c. The band-pass filter (BPF) 153 a filter circuit for limiting a frequency of an audio signal to be reproduced to a frequency band corresponding to low audio frequencies. The dynamic speaker 17c can function as a speaker for low audio frequencies, by the band-pass filter (BPF) 153.

The band-pass filter (BPF) 154 is a filter circuit for limiting a frequency of an audio signal to be reproduced to a frequency band corresponding to middle audio frequencies. The dynamic speakers 17a, 17b can function as speakers for middle audio frequencies, by the band-pass filter (BPF) 154.

The high-pass filter (HPF) 155 is a filter circuit which has a higher cutoff frequency than a frequency band corresponding to middle audio frequencies and which limits a frequency of an audio signal to be reproduced to a higher frequency band than the cutoff frequency. The piezoelectric speakers 16a, 16b can function as speakers for high audio frequencies, by the high-pass filter (HPF) 155. In addition, the high-pass filter (HPF) 155 is configured to have the cutoff frequency value varied in accordance with the cutoff frequency switch signal transmitted from the EC/KBC 160.

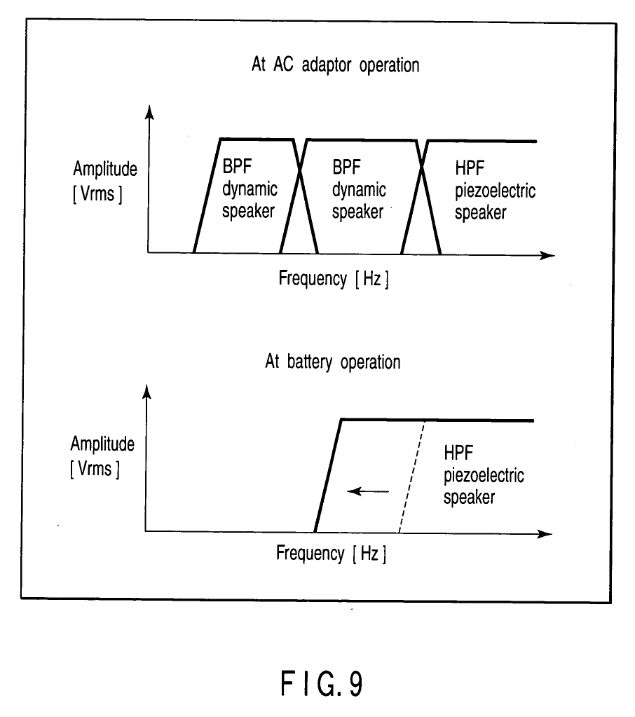

In FIG. 8, not only the driving of the dynamic speakers 17a, 17b, 17c but also that of the piezoelectric speakers 16a, 16b is permitted when the computer 10 is driven by the external power. In this case, sound of the low audio frequencies is reproduced by the dynamic speaker 17c, sound of the middle audio frequencies is reproduced by the dynamic speakers 17a, 17b, and sound of the high audio frequencies is reproduced by the piezoelectric speakers 16a, 16b, as illustrated as “At AC adaptor operation” in FIG. 9. Since the piezoelectric speakers 16a, 16b are superior in acoustic performance in high frequencies, sound of preferable quality can be output by utilizing all of the speakers built in the computer 10 when the computer 10 is driven by the external power.

On the other hand, when the computer 10 is driven by the battery 181, the driving of the dynamic speakers 17a, 17b, 17c is prohibited while the driving of the piezoelectric speakers 16a, 16b is permitted. In this case, the cutoff frequency of the high-pass filter (HPF) 155 is automatically lowered to the middle frequencies as illustrated as “At battery operation” in FIG. 9. Sounds of middle and high frequencies can be therefore output by the piezoelectric speakers 16a, 16b.

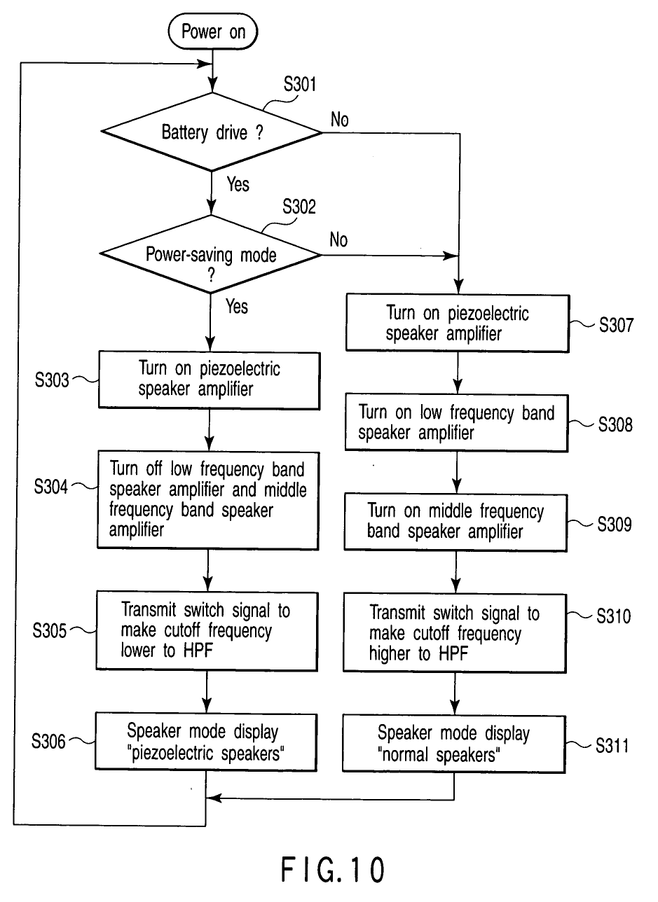

Next, an example of speaker driving control processing applied to the system of FIG. 8 is explained with reference to a flowchart of FIG. 10.

When the power to the computer is turned on, the EC/KBC 160 cooperates with the power supply circuit 180 to discriminate whether the computer 10 is driven by the battery 181 or the external power (step S301).

If the EC/KBC 160 discriminates that the computer 10 is driven by the battery 181 (YES in step S301), the EC/KBC 160 discriminates whether or not the operation mode of the computer 10 is the power-saving mode (step S302). If the operation mode of the computer 10 is the power-saving mode (YES in step S302), the EC/KBC 160 turns on the power to the piezoelectric speaker amplifier 152 to permit the driving of the piezoelectric speakers 16a, 16b (step S303). In step S303, the EC/KBC 160 stops the output of the PowerDown signal to the piezoelectric speaker amplifier 152. The power to the piezoelectric speaker amplifier 152 is thereby turned on. Next, the EC/KBC 160 turns off the power to the dynamic speaker amplifier (low frequency band speaker amplifier) 156 and the dynamic speaker amplifier (middle frequency band speaker amplifier) 151 to prohibit the driving of the dynamic speakers 17a, 17b, 17c (step S304). In step S304, the EC/KBC 160 transmits the PowerDown signal to each of the dynamic speaker amplifier (low frequency band speaker amplifier) 156 and the dynamic speaker amplifier (middle frequency band speaker amplifier) 151. The power to the dynamic speaker amplifier (low frequency band speaker amplifier) 156 and the dynamic speaker amplifier (middle frequency band speaker amplifier) 151 is thereby turned off. Next, the EC/KBC 160 transmits a cutoff frequency switch signal to the HPF 155 to lower the cutoff frequency of the HPF 155 to middle frequencies (step S305). After that, the EC/KBC 160 executes the processing of showing the information indicating that the driving of the piezoelectric speakers 16a, 16b is permitted (step S306). In step 306, the EC/KBC 160 cooperates with the power supply circuit 180 to turn on the light on the indicator 19. Furthermore, the EC/KBC 160 cooperates with the display driver, etc. to urge the icon 310 indicating that the speakers to be used are the piezoelectric speakers 16a, 16b to be displayed on the screen of the LCD 20.

On the other hand, if the EC/KBC 160 discriminates that the computer 10 is driven by the external power (NO in step S301) or if the computer 10 is set in the normal mode (NO in step S302), the EC/KBC 160 turns on the power to the piezoelectric speaker amplifier 152 to permit the driving of the piezoelectric speakers 16a, 16b (step S307). In step S307, the EC/KBC 160 stops the output of the PowerDown signal to the piezoelectric speaker amplifier 152. The power to the piezoelectric speaker amplifier 152 is thereby turned on. Next, the EC/KBC 160 turns on the power to the dynamic speaker amplifier (low frequency band speaker amplifier) 156 and the dynamic speaker amplifier (middle frequency band speaker amplifier) 151 to permit the driving of the dynamic speakers 17a, 17b, 17c (steps S308, S309). In steps S308 and S309, the EC/KBC 160 stops the output of the PowerDown signal to the dynamic speaker amplifier (low frequency band speaker amplifier) 156 and the dynamic speaker amplifier (middle frequency band speaker amplifier) 151. The power to the dynamic speaker amplifier (low frequency band speaker amplifier) 156 and the dynamic speaker amplifier (middle frequency band speaker amplifier) 151 is thereby turned on.

Next, the EC/KBC 160 transmits a cutoff frequency switch signal to the HPF 155 to set the cutoff frequency of the HPF 155 to be higher than the middle frequency band (step S310). The EC/KBC 160 executes the processing of showing the information indicating that the driving of all of the speakers is permitted (step S311). In step 311, the EC/KBC 160 cooperates with the power supply circuit 180 to turn on the light on the indicators 18 and 19. Furthermore, the EC/KBC 160 cooperates with the display driver, etc. to urge the icon 310 indicating that all of the speakers are used to be displayed.

The BPF 153, the dynamic speaker amplifier (low frequency band speaker amplifier) 156 and the dynamic speaker 17c are not required. The dynamic speakers 17a, 17b may be used as speakers for low and middle audio frequencies by extending the bandwidth of the BPF 154.

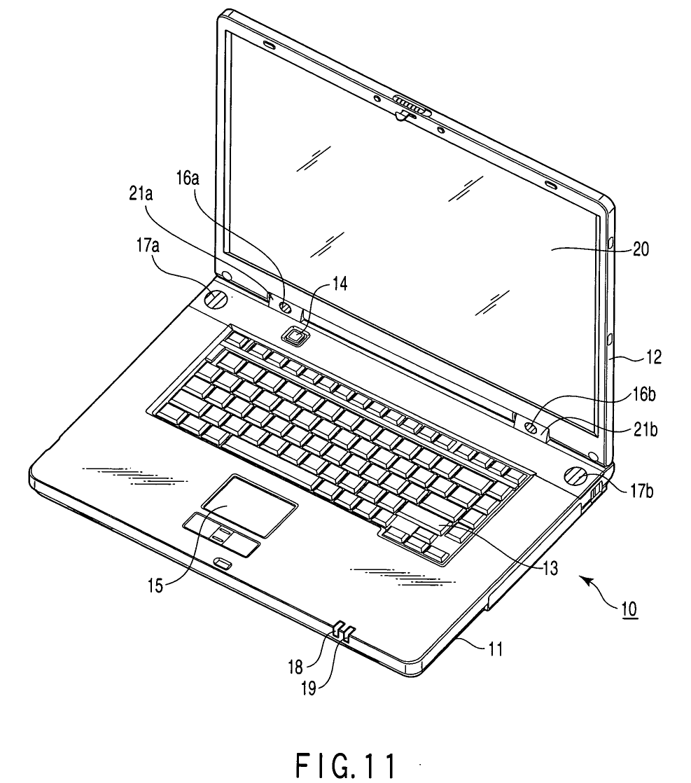

FIG. 11 shows another example of the arrangement of the piezoelectric speakers 16a, 16b and the dynamic speakers 17a, 17b, 17c.

In FIG. 11, the piezoelectric speakers 16a, 16b are not provided on the display unit 12, but on projections 21a, 21b formed on the base unit 11, respectively. The projections 21a, 21b project from a rear end portion of the base unit 11. The projections 21a, 21b have mounting surfaces facing the front side, respectively. The piezoelectric speakers 16a, 16b are provided on the mounting surfaces, respectively. In this case, each of the dynamic speakers 17a, 17b, and each of the piezoelectric speakers 16a, 16b are displaced from each other along the direction of the rotary axis of the display unit 12. Therefore, overlapping of the sound field from each of the dynamic speakers 17a, 17b and the sound field from each of the piezoelectric speakers 16a, 16b can be prevented.

In FIG. 11, the projections 21a, 21b also function as hinge portions for supporting the display unit 12. Hinge portions may be provided, aside from the projections 21a, 21b.

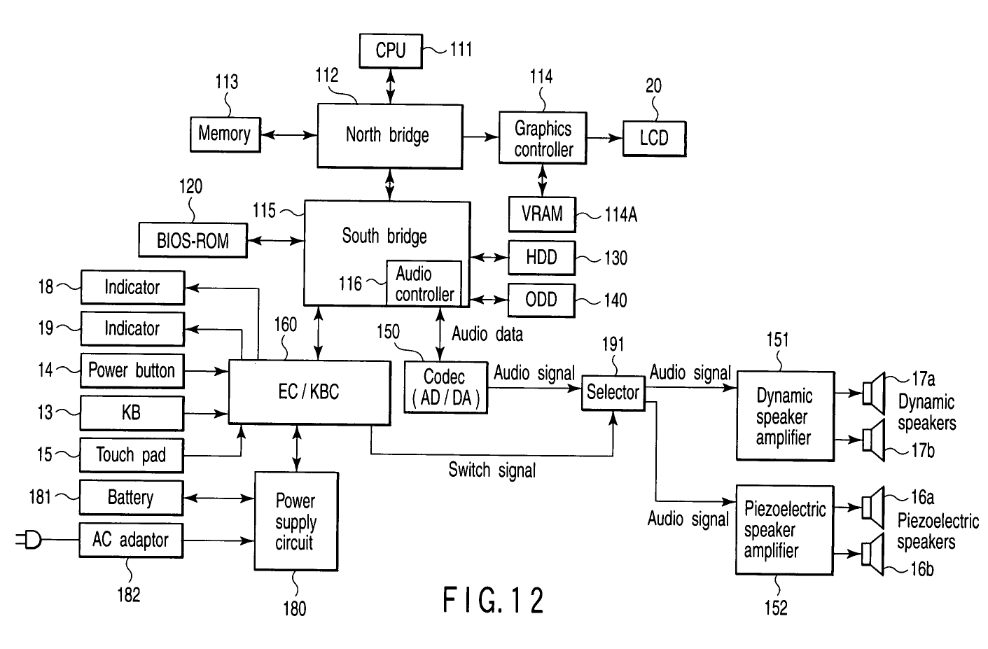

Next, a third example of the system configuration of the computer 10 is explained with reference to FIG. 12. Elements like or similar to those shown in FIG. 3 are denoted by similar reference numbers in FIG. 12 and are not described in detail here. In the system of FIG. 12, a selector 191 is provided between the audio codec 150 and the dynamic speaker amplifier 151 and piezoelectric speaker amplifier 152. The selector 191 is a circuit for selectively supplying the audio signal to the piezoelectric speakers 16a, 16b and the dynamic speakers 17a, 17b. The selector 191 transmits the audio signal input from the audio codec 150 to any one of the dynamic speaker amplifier 151 and piezoelectric speaker amplifier 152 in accordance with the switch signal transmitted from the EC/KBC 160.

If the computer 10 is driven by the external power, the EC/KBC 160 controls the selector 191 with the switch signal to permit the audio signal to be supplied to the dynamic speakers 17a, 17b via the dynamic speaker amplifier 151. On the other hand, if the computer 10 is driven by the battery 181, the EC/KBC 160 controls the selector 191 with the switch signal to permit the audio signal to be supplied to the piezoelectric speakers 16a, 16b the piezoelectric speaker amplifier 152 and prohibit the audio signal from being supplied to the dynamic speakers 17a, 17b via the dynamic speaker amplifier 151.

When the computer 10 is driven by the external power, the EC/KBC 160 may permit the audio signal to be supplied to the piezoelectric speakers 16a, 16b and the dynamic speakers 17a, 17b.

As described above, two kinds of speakers, dynamic speakers and piezoelectric speakers are provided on the computer 10 of the present embodiment. When the computer 10 is driven by the external power, at least the dynamic speakers are used. When the computer 10 is driven by the battery 181, the speakers to be driven are switched to the piezoelectric speakers. Therefore, both the reproduction of the audio signal having a sufficient sound quality and the low power consumption at the battery drive time can be achieved.

In the present embodiment, the speaker drive control is executed by the EC/KBC 160, but may be executed by, for example, the BIOS.

In addition, the present embodiment uses two piezoelectric speakers functioning as stereo speakers and two dynamic speakers functioning as stereo speakers. However, one piezoelectric speaker and one dynamic speaker may be provided.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus driven by one of a battery and an external power, comprising:
a main body;
a dynamic speaker provided on the main body;
a piezoelectric speaker provided on the main body;
means for detecting whether the main body is driven by the battery or the external power; and
control means for permitting the driving of the dynamic speaker, when detecting means detects that the main body is driven by the external power, and for permitting the driving of the piezoelectric speaker and prohibiting the driving of the dynamic speaker when detecting means detects that the main body is driven by the battery.

2. The electronic apparatus according to claim 1, further comprising:
a first amplifier which drives the dynamic speaker; and
a second amplifier which drives the piezoelectric speaker,
wherein the control means comprises means for setting at least the first amplifier, of the first and second amplifiers, to be turned on, when it is discriminated that the main body is driven by the external power, and for setting the second amplifier to be turned on and the first amplifier to be turned off when detecting means detects that the main body is driven by the battery.

3. The electronic apparatus according to claim 1, wherein the control means comprises means for permitting an audio signal to be supplied to the dynamic speaker, when detecting means detects that the main body is driven by the external power, and for permitting the audio signal to be supplied to piezoelectric speaker and prohibiting the audio signal from being supplied to the dynamic speaker when detecting means detects that the main body is driven by the battery.

4. The electronic apparatus according to claim 1, wherein the control means comprises:
means for detecting a remaining capacitance of the battery when detecting means detects that the main body is driven by the battery; and
means for permitting the driving of dynamic speaker, when the remaining capacitance of the battery is higher than a threshold value, and for permitting the driving of the piezoelectric speaker and prohibiting the driving of the dynamic speaker when the remaining capacitance of the battery is below the threshold value.

5. The electronic apparatus according to claim 1, further comprising means for displaying status information representing the driving of the speaker which is permitted to be driven, of the dynamic speaker and the piezoelectric speaker.

6. The electronic apparatus according to claim 1, further comprising:
a first filter circuit which limits a frequency of an audio signal to be reproduced to a first frequency band and supplies the audio signal to the dynamic speaker; and
a second filter circuit which has a higher cutoff frequency than the first frequency band, and which limits the frequency of the audio signal to be reproduced to a higher frequency band than the cutoff frequency and supplies the audio signal to the piezoelectric speaker,
wherein the control means comprises means for permitting the driving of both the dynamic speaker and the piezoelectric speaker when detecting means detects that the main body is driven by the external power, and for lowering a value of a cutoff frequency of the second filter circuit, permitting the driving of the piezoelectric speaker and prohibiting the driving of the dynamic speaker when detecting means detects that the main body is driven by the battery.

7. The electronic apparatus according to claim 1, wherein the main body is composed of a base unit and a display unit attached to the base unit to freely pivot between a closed position at which the display unit covers a top surface of the base unit and an opened position at which the top surface of the base unit is exposed;
the dynamic speaker is provided on the top surface of the base unit; and
the piezoelectric speaker is provided on the display unit.

8. The electronic apparatus according to claim 7, wherein the dynamic speaker and the piezoelectric speaker are displayed from each other along a direction of a rotary axis of the display unit.

9. The electronic apparatus according to claim 1, wherein the main body is composed of a base unit, a display unit attached to the base unit to freely pivot between a closed position at which the display unit covers a top surface of the base unit and an opened position at which the top surface of the base unit is exposed, and a projection which is provided at a rear end portion of the base unit and which has a mounting surface arranged to face a front side;
the dynamic speaker is provided on the top surface of the base unit; and
the piezoelectric speaker is provided on the mounting surface of the projection.

10. A speaker drive controlling method, of controlling drive of a piezoelectric speaker and a dynamic speaker provided on an electronic apparatus driven by any one of a battery and an external power, the method comprising:
discriminating whether the electronic apparatus is driven by the external power or the battery; and
permitting the driving of the dynamic speaker, when detecting means detects that the electronic apparatus is driven by the external power, and permitting the driving of the piezoelectric speaker and prohibiting the driving of the dynamic speaker when detecting means detects that the electronic apparatus is driven by the battery.

11. The method according to claim 10, wherein the electronic apparatus comprises a first amplifier which drives the dynamic speaker and a second amplifier which drives the piezoelectric speaker; and
the control sets at least the first amplifier, of the first and second amplifiers, to be turned on when detecting means detects that the electronic apparatus is driven by the external power, and sets the second amplifier to be turned on and the first amplifier to be turned off when detecting means detects that the electronic apparatus is driven by the battery.

12. The method according to claim 10, wherein the electronic apparatus further comprises:
a first filter circuit which limits a frequency of an audio signal to be reproduced to a first frequency band and supplies the audio signal to the dynamic speaker; and
a second filter circuit which has a higher cutoff frequency than the first frequency band, and which limits the frequency of the audio signal to be reproduced to a higher frequency band than the cutoff frequency and supplies the audio signal to the piezoelectric speaker, and
wherein the control permits the driving of both the dynamic speaker and the piezoelectric speaker when detecting means detects that the electronic apparatus is driven by the external power, and lowers a value of a cutoff frequency of the second filter circuit, permits the driving of the piezoelectric speaker and prohibits the driving of the dynamic speaker when detecting means detects that the electronic apparatus is driven by the battery.
